(19) United States
(12) Patent Application Publication
(10) Pub. No.: US 2002/0182302 A1
(43) Pub. Date: Dec. 5, 2002

(54) Mrs. Mars natural mix: banango-berry, blueberry-remmon, cherry-kiwi, ginger-fruit, graple-berry, pine-berry, and raspberry-remmon, a family tradition secret method and recipe is a unique combination of frozen extracted fresh raw fruit juices containing their natural live enzymes, fiber, vitamins, minerals and trace minerals

(76) Inventor: Margaret Ann Rawls, Neptune, NJ (US)

Correspondence Address: Margaret Ann Rawls, 29 Winding Ridge Court, Neptune, NJ, 07753, US

(21) Appl. No.: 10/157,470

(22) Filed: May 29, 2002

Related U.S. Application Data
(60) Provisional application No. 60/272,918, filed on Jun. 1, 2001.

(51) Int. Cl. A23L 2/00

(52) U.S. Cl. 426/599

(57) ABSTRACT

The use of a masticating juice extractor has made it possible to provide the highest quality 100% all natural pure fresh raw fruit juice. The mastication juicer literally chews fruit fibers sufficiently to release fibers, enzymes, vitamins, minerals, and trace minerals. The mastication juicer sufficiently chews fruit fibers that it produces a fresh fruit juice that is darker and richer in color, sweeter, rich, and more full-bodied than any beverage on the market. The juice is quickly frozen to retain its nutritive properties and delicious fresh fruit taste. The combination of specific fruits, in specific quantities, in a specific order in the mastication juice extractor produces a juice of superior uniquely different taste that all who taste them exclaim immediately that they are truly different.

### CROSS REFERENCE TO RELATED APPLICAFIONS

Not Applicable

### STATEMENT REGARDING FED SPONSORED R AND D

Not Applicable

### REFERENCE TO SEQUENCE LISTING, A TABLE, OR COMPUTER PROGRAM LISTING APPENDIX

Not Applicable

### BACKGROUND OF THE INVENTION

The field of endeavor to which the invention pertains is frozen all natural raw fruit juices. The subject matter is 100% all natural, extracted raw fruit juices that are quickly frozen.

With the birth of our first child, it became apparent to me that the Medical profession only dealt with disease. In my quest to learn how to protect my family from disease, I began to research the causes of disease. I discovered that research studies repeatedly showed a direct relationship between diet and health. Research studies also showed that a diet of raw foods promoted health and prevented disease. The problem was how do I get my family to eat raw foods and like them enough to make them a permanent part of their daily diet.

In 1979, my two year old had a persistent cough that the Pediatrician tried unsuccessfully to treat for weeks. In my frustration, I took her off milk and cooked foods and gave her combinations of raw vegetable juices for her meals. I also gave her a combination of raw fruit juices for dessert and to replace carbonated sodas and pasteurized commercial fruit juices. Amazingly the cough cleared up in a couple of days and was completely gone in a week.

Over the last 25 years, I have developed and perfected several combinations of extracted fruit juices that are truly unique in taste. My family drinks them daily. Our friends beg for them. People call and ask to purchase the juice combinations. Besides being unique in taste, the method of extraction comes close to 90% of what the human digestive system extracts from food ingested. This has become possible by the invention of the masticating juice extractor made by the Champion Juicer Company. The combination of this juicer and our juice formulations has resulted in the invention that makes it possible for the average American to have 100% all natural raw fruit juice available at an affordable price. These raw fruit juices fill a nutritive void in the American diet.

### BRIEF SUMMARY OF THE INVENTION

The subject of the invention lies in the specific order and quantity of specific types of whole raw fruits being fed into a slow speed masticating juice extractor. This process sufficiently breaks down the fiber of the whole raw fruit and then breaks up the cells. The resultant extracted raw juice has more fiber, live enzymes, vitamins, minerals, trace mineral, and natural flavors than juices extracted using the popular centrifugal method. The flavors are new and different and cannot be duplicated unless this process is followed closely.

The specific quantities of the whole raw fruits were submitted with the provisional patent application: No. 60/272,918 dated Jun. 1, 2001. Six variations of each formulation were included in efforts to protect my invention and prevent competitors from formulating similar tasting 100% extracted fruit juices from raw whole fruits. The nutritional value of each uniquely developed combination, of each formulation, is enhanced by adding them together. The juices are poured into small bottle containers and quickly frozen to retain their nutritive properties.

There are several advantages of our inventive process. The American Heart and Cancer Societies are advocating that Americans eat 3-5 servings of raw fresh fruit daily. Raw fresh fruit stimulates the bowels and intestines, helping to rid the body of toxins. They also help cleanse the liver and kidneys. Each formulation of our raw fruit juices has apples and grapes as basic ingredients. The live enzyme action of apples and grapes stimulate the bowels and intestines and cleanses the kidneys and liver.

In an effort to feed America our supernarkets are stocked with shelves of denatured and over processed foods which have been fortified to be of any nutritive value. The human body recognizes its nutritive needs. The average American overeats denatured foods in an effort to be nutritively satisfied. Rather than continue to constume carbonated sugar drinks and pasteurized fruit juices, which only contain 5-10% real fruit juice, our raw fruit juices would be available in the frozen food section and vending machines. This would greatly reduce the intake of processed sugar, which is a leading contributory to diabetes and obesity.

Many physicians agree that pancreatic dysfunction is a leading cause of diabetes. Because of this the American Diabetic Association advocates that diabetics increase their intake of fresh raw fruits. Fresh raw fruits would provide the natural enzymes needed for digestion. Therefore reducing the load on the pancreas to produce enzymes that are not provided in over processed pasteurized foods. Our raw fruit juices contain the enzymes from 13 fruits, the combination of which would meet the needs of nearly all-digestive challenges.

And lastly eating a diet devoid of nutritive value leaves the average American tired and listless. Since our raw fruit juices do not need to be digested, they enter the bloodstream with little or no work or effort by the body, and they are immediately transformed into needed starches and sugars, which are used at the cell-level to provide energy. The objective of our invention is to provide a readily available, easy source, of deliciously tasting affordable raw fruit juices. These juices will have a definite and demonstrative effect on the overall nutritive health of all who consume them.

### DETAILED DESCRIPTION

Our invention has a specific order in which whole raw fruits are masticated and their juice extracted. The whole raw fruits include the entire fruit of the following fruits, except where noted:

1. Golden Delicious, Gala, or Red Delicious Apples

2. Strawberries

3. Blueberries

4. Raspberries

5. Cranberries

6. Lemons

7. Red, Purple, White, or Green Grapes

8. Cherries

9. Kiwis (outer peel removed)

10. Oranges (orange color only removed, white pith and membrane retained))

111. Pineapples (outer peel removed)

12. Mangoes (outer peel removed)

13. Bananas (outer peel removed)

Slow mastication is the process of breaking food fiber down sufficiently that the live enzymes in the juice are liberated. This process also involves the breaking down at the cellular level to liberate the vitamins, minerals, and trace minerals. It is the same natural process the body uses when the teeth masticate foods and the stomach and small intestines extract the liquid from the food. The nutritive juices are deposited into the portal vein for distribution by the liver to the bodies 60 trillion cells. All fruits are soaked in Dr. Brauner's Sal Suds (effective, concentrated, mild, biodegradable cleaner) before being washed and rinsed with pure water.

The specific order of the fruits being slowly masticated is outlined below.* The specific quantity of specific types of whole raw fruits was submitted with the provisional patent application: No. 60/272,918 Dated Jun. 1, 2001. Depending upon which formulation is being made, from 4-7 fresh raw fruits must be fed into a slow speed masticating juice extractor. This process will sufficiently break down the fiber of the whole fruit and then break up the cells. The resultant extracted juice has more fiber, enzymes, vitamins, minerals, trace minerals, and natural flavors than juices extracted using the popular centrifugal method. There are 14 popular juicers on the market today. Only one is a masticating type (the Champion Juicer). The other 13 are centrifugal juice extractors. They break food up as a circular round blade revolves at a high speed. The centrifugal force generated by the circular revolution forces the extracted juice out of the machine. Unlike the centrifugal method, the masticating machine has a conical type blade housed in a closed body. The conical blade chews up fiber more efficiently than the average human chews his food. The slower speed combined with the closed housing consistently yields more fibers enzymes, vitamins, minerals, trace minerals, and natural flavors. According to the manufacturer of the Champion machine the resultant juice is, “darker, richer in color . . . sweeter, rich”, with a, “more full body flavor”. Our flavors are totally new and different and cannot be duplicated unless this process in followed closely.

Six variations on each formulation were included in the provisional patent in efforts to prevent competitors from formulating similar tasting 100% pure extracted raw fruit juices from whole fruits. The nutritional value of each uniquely developed combination, of each formulation, is enhanced by adding them together. For example, when you add masticated extracted raw apple juice with masticated extracted raw grape juice, you get a synergetic effect on the bowels, intestines, kidneys, and liver.

The juices are poured into small bottle containers and quickly frozen to retain their nutritive values. Small containers are used so that once they are opened for consumption the entire contents will be consumed. The juices are designed to be consumed in a slush (icy) form. The juices are quickly frozen to retain their nutritive value and should be consumed completely upon opening. There are reports of fresh foods found in the stomachs of dinosaurs who where frozen quickly, reportedly during the Ice Age. In addition, frozen vegetables are more similar in nutritive value to fresh raw vegetables, especially when compared to canned vegetables.

Ninety-five percent of all fruit juices are pasteurized and devitalized during processing. In addition, they are only 5-10% real fruit juice, the rest being water. A few apple and grape juices are 100% fruit juice, but they are pasteurized, therefore destroying all enzymes, vitamins and minerals. Most fruit juices and soft drink type beverages also have sugar, sucrose, cornstarch, or some method to add a sweetener. The only few non-pasteurized juices are all either all orange juice or all vegetable juice. They are not readily available, and their taste is not competitive with popular soft drinks. No one offers a 100% pure all natural raw fruit juice with all its nutritive values; and a delicious combination of fruits, which produce a taste that can compete effectively with popular soft drinks. It is an ideal healthful drink for school-age children, older ones in nursing homes and hospitals, and for the general population trying to reduce their intake of processed sugars and or improve their diets in a nutritive way.

The specific order and types of whole fruits of each formulation follows:

1. Graple-Berry

Golden Delicious, Gala, or Red Delicious Apples

Strawberries

Golden Delicious, Gala, or Red Delicious Apples

Red or Purple Grapes

Golden Delicious, Gala, or Red Delicious Apples

Lemons

Golden Delicious, Gala, or Red Delicious Apples

2. Ginger-Fruit

Golden Delicious or Gala Apples

Oranges

White or Green Grapes

Mangoes

Golden Delicious or Gala Apples

Golden Pineapples

Ginger Root

Golden Delicious or Gala Apples

3. Pine-Berry

Golden Delicious, Gala, or Red Delicious Apples

Cranberries

Golden Pineapples

Red or Purple Grapes

Golden Delicious, Gala, or Red Delicious Apples

4. Raspberry-Remmon

Golden Delicious, Gala, or Red Delicious Apples

Raspberries

Golden Delicious, Gala, or Red Delicious ripples

Red or Purple Grapes

Lemons

Golden Delicious, Gala, or Red Delicious Apples

5. Blueberry-Remmon

Golden Delicious, Gala, or Red Delicious Apples

Blueberries

Golden Delicious, Gala, or Red Delicious Apples

Red or Purple Grapes

Lemons

Golden Delicious, Gala, or Red Delicious Apples

6. Banango-Berry

Golden Delicious, Gala, or Red Delicious Apples

Strawberries

Golden Delicious, Gala, or Red Delicious Apples

Mangoes

Golden Pineapples

Bananas (blended and homogenized)

7. Cherry-Kiwi

Golden Delicious, Gala, or Red Delicious Apples

Kiwis

Golden Delicious, Gala, or Red Delicious Apples

Cherries

Golden Delicious, Gala, or Red Delicious Apples

Mangoes

Red or Purple Grapes

Golden Delicious, Gala, or Red Delicious Apples

Lemons

Golden Delicious, Gala, or Red Delicious Apples

1. I claim that the mastication process of juice extraction, of specific fresh raw fruits, in a specific order, produces a 100% pure raw fruit juice of sufficiently superior nutritive value that when consumed will greatly improve the nutritive diet of the one who consumes the juice on a regular basis.
These fruit juices are not pasteurized and they are quickly frozen to retain their nutritive value.
These fruit juices are bottled in small containers so that they are consumed completely upon opening.
These fruit juices will fill a nutritive void in the American diet by being available in the frozen food section of supermarkets and vending machine locations.

2. I claim that the mastication process of juice extraction, of specific fresh raw fruits, in specific quantities, in a specific order, produces a 100% pure fruit juice of sufficiently delicious, superior and unique taste that they can compete on the open market with the top selling soft drinks.
The six additional formulations for each of the seven different flavors is the only way the flavors can come close to being duplicated.
The juices are consumed in a slush (icy) form to encourage the juices to be consumed slowly to enjoy the unique flavors.
